(19) United States
(12) Patent Application Publication
(10) Pub. No.: US 2024/0095106 A1
(43) Pub. Date: Mar. 21, 2024

(54) Single-step collective operations

(71) Applicant: Mellanox Technologies, Ltd., Yokneam (IL)

(72) Inventor: Richard Graham, Knoxville, TN (US)

(21) Appl. No.: 18/105,846

(22) Filed: Feb. 5, 2023

Related U.S. Application Data
(60) Provisional application No. 63/405,505, filed on Sep. 12, 2022.

(51) Int. Cl. G06F 9/54

(52) U.S. Cl. CPC G06F 9/546

(57) ABSTRACT

A method for collective communications includes invoking a collective operation over a group of computing processes in which the processes concurrently transmit and receive data to and from other processes in the group via a communication medium. Messages are composed for transmission by source processes including metadata indicating how the data to be transmitted by the source processes in the collective operation are to be handled by destination processes that are to receive the data and also including in at least some of the messages the data to be transmitted by one or more of the source processes to one or more of the destination processes. The composed messages are transmitted concurrently from the source processes to the destination processes in the group over the communication medium. The data are processed by the destination processes in response to the metadata included in the messages received by the destination processes.

### CROSS-REFERENCE TO RELATED APPLICATION

This application claims the benefit of U.S. Provisional Patent Application 63/405,505, filed Sep. 12, 2022, which is incorporated herein by reference.

### FIELD

The present invention relates generally to high-performance computing (HPC), and particularly to communication among collaborating software processes using collective operations.

### BACKGROUND

Collective communications are used by groups of computing nodes to exchange data in connection with a distributed processing application. In HPC, for example, the nodes are typically software processes running in parallel, for example on different computing cores. The nodes exchange collective communications with one another in connection with parallel program tasks carried out by the processes. The term “collective operation” is used in the present description and in the claims to refer to functions performed concurrently by multiple processes (and possibly all the processes) participating in a parallel processing task. These collective operations typically include communication functions, in which the processes in the group concurrently transmit and receive data to and from other processes in the group via a communication medium. These functions are referred to as “collective communications.” The collective communications among processes may be exchanged over any suitable communication medium, such as over a physical network, for example a high-speed switch fabric or packet network, or via shared memory within a computer.

Various protocols have been developed to support collective communications. One of the best-known protocols is the Message Passing Interface (MPI), which enables processes to move data from their own address spaces to the address spaces of other processes through cooperative operations carried out by each process in a process group. In MPI parlance, the process group is referred to as a “communicator,” and each member process is identified as a “rank.” MPI collective operations include all-to-all, all-to-all-v, and all-to-all-w operations, which gather and scatter data from all ranks to all other ranks in a communicator. In the operation all-to-all, each process in the communicator sends a fixed-size message to each of the other processes. The operations all-to-all-v and all-to-all-w are similar to the operation all-to-all, but the messages may differ in size. In all-to-all-w, the messages may also contain different data types.

In naïve implementations of all-to-all-v and all-to-all-w, each member process transmits messages to all other member processes in the group. In large-scale HPC distributed applications, the group can include thousands of processes running on respective processing cores, meaning that millions of messages are exchanged following each processing stage. To reduce the communication burden associated with this message exchange, message aggregation protocols have been proposed.

For example, U.S. Pat. No. 10,521,283 describes in-node aggregation of MPI all-to-all and all-to-all-v collectives. An MPI collective operation is carried out in a fabric of network elements by transmitting MPI messages from all the initiator processes in an initiator node to designated responder processes in respective responder nodes. Respective payloads of the MPI messages are combined in a network interface device of the initiator node to form an aggregated MPI message. The aggregated MPI message is transmitted through the fabric to network interface devices of responder nodes, which disaggregate the aggregated MPI message into individual messages and distribute the individual messages to the designated responder node processes.

### SUMMARY

Embodiments of the present invention that are described hereinbelow provide efficient methods for collective communications, as well as systems and software implementing such methods.

There is therefore provided, in accordance with an embodiment of the invention, a method for collective communications, which includes invoking a collective operation over a group of computing processes in which the processes in the group concurrently transmit and receive data to and from other processes in the group via a communication medium. Messages are composed for transmission by source processes in the group, including metadata indicating how the data to be transmitted by the source processes in the collective operation are to be handled by destination processes that are to receive the data and also including in at least some of the messages the data to be transmitted by one or more of the source processes to one or more of the destination processes. The composed messages are transmitted concurrently from the source processes to the destination processes in the group over the communication medium. The data are processed by the destination processes in response to the metadata included in the messages received by the destination processes.

In a disclosed embodiment, composing the messages includes incorporating the data together with the metadata in the messages when a size of the data for transmission from a given source process to a given destination process is less than a predefined threshold, and transmitting only the metadata without the data when the size of the data for transmission from the given source process to the given destination process is greater than the predefined threshold, whereby the destination process retrieves the data from the source process using the metadata in the messages.

Additionally or alternatively, transmitting the composed messages includes, for at least some of the messages, transmitting the messages having respective sizes that are greater than a predefined threshold to the destination processes without aggregation, and aggregating the messages for which the respective sizes are less than the predefined threshold and transmitting the aggregated messages to the destination processes.

In some embodiments, processing the data includes transmitting, responsively to the metadata in a message received by a destination process, a request from the destination process to the source process to convey the data from the source process to the destination process, whereby the source process transmits the data to the destination process responsively to the request. In a disclosed embodiment, transmitting the request includes transmitting a remote direct memory access (RDMA) read request from the destination process to the source process.

In some embodiments, invoking the collective operation includes initiating an all-to-all-v, all-to-all-w, all-gather-v, gather-v, or scatter-v operation.

There is also provided, in accordance with an embodiment of the invention, a system for collective communications, including multiple processors, which are interconnected by a communication medium and are programmed to run respective computing processes. Upon receiving an invocation of a collective operation over a group of the processes in which the processes in the group are to concurrently transmit and receive data to and from other processes in the group via a communication medium, the processors compose, for transmission by source processes in the group, messages including metadata indicating how the data to be transmitted by the source processes in the collective operation are to be handled by destination processes that are to receive the data and also including in at least some of the messages the data to be transmitted by one or more of the source processes to one or more of the destination processes. The processors transmit the composed messages concurrently from the source processes to the destination processes in the group over the communication medium. The processors process the data in the destination processes in response to the metadata included in the messages received by the destination processes.

There is additionally provided, in accordance with an embodiment of the invention, a computer software product for collective communications among a group of computing processes running on processors, which are interconnected by a communication medium. The product includes a tangible, non-transitory computer-readable medium in which program instructions are stored, which instructions cause the processors, upon receiving an invocation of a collective operation over a group of the processes in which the processes in the group are to concurrently transmit and receive data to and from other processes in the group via a communication medium, to compose, for transmission by source processes in the group, messages including metadata indicating how the data to be transmitted by the source processes in the collective operation are to be handled by destination processes that are to receive the data and also including in at least some of the messages the data to be transmitted by one or more of the source processes to one or more of the destination processes. The instructions cause the processors to transmit the composed messages concurrently from the source processes to the destination processes in the group over the communication medium, and to process the data in the destination processes in response to the metadata included in the messages received by the destination processes.

The present invention will be more fully understood from the following detailed description of the embodiments thereof, taken together with the drawings in which:

### BRIEF DESCRIPTION OF THE DRAWINGS

FIG. 1 is a block diagram that schematically illustrates collective communications in a computer system, in accordance with an embodiment of the invention;

FIG. 2 is a flow chart that schematically illustrates a method for collective communications, in accordance with an embodiment of the invention; and

FIGS. 3 and 4 are ladder diagrams that schematically illustrate collective communication exchanges between source and destination processes, in accordance with embodiments of the invention.

### DETAILED DESCRIPTION

### Overview

In collective communications, destination processes do not necessarily have information about the messages that they are to receive from source processes until the messages actually arrive. In all-to-all-v operations, for example, the processes in a group may not have any advance indication of their own as to which source processes are going to send them data in a given operation or how much data a given source process is going to send. This uncertainty can lead to bottlenecks and inefficiencies in handling the data at the destination processes.

In some applications, this uncertainty is alleviated by performing two collective operations in each round of communications: In the first operation, the processes exchange metadata to inform the destination processes how much data to expect, of what type, and from which source processes. This first operation can be carried out using all-to-all operation, for example. In the second operation, such as an all-to-all-v operation, the processes exchange the actual data. This two-stage model makes the programmer's job easier, but at the cost of increased communication load and latency.

Embodiments of the present invention that are described herein address the shortcomings of these existing models by enabling the processes in a group to exchange both metadata and data in a single collective operation. When a collective operation is invoked over the group of computing processes, the source processes in the group identify the data that they are going to transmit to respective destination processes, along with metadata indicating how the data are to be handled by each destination process. The source processes compose messages containing the metadata for transmission to the respective destination processes. Some of the messages may comprise only metadata, for example messages to destination nodes for which the source node has a large volume of data to transmit. Such messages enable the destination process to prepare an application buffer to receive the data before the actual transmission of the data. Other messages, however, comprise the actual data to be transmitted to a given destination processes, together with the metadata.

The source processes concurrently transmit these messages (including messages containing only metadata and messages containing both metadata and data) to the destination processes in the group over a communication medium. Upon receiving the messages, the destination processes use the metadata comprised in the messages that they have received in processing the data.

Some embodiments are directed particularly to implementing collective operations in which message sizes are not known in advance, such as all-to-all-v, all-to-all-w, all-gather-v, gather-v, and scatter-v. In such operations, the source process will incorporate the data together with the metadata in a given message when the size of the data for transmission from the source process to a given destination process is less than a predefined threshold. On the other hand, when the size of the data for transmission from the source process to a given destination process is greater than the predefined threshold, the source process will transmit only the metadata without the data in the message that it sends in the collective operation. The destination process will then use the metadata that it received in the message in retrieving the data from the source process in an additional step following the collective message exchange. For example, the destination process may use the metadata in transmitting a request to the source process, such as a remote direct memory access (RDMA) read request, to transmit the data to the destination process.

In some embodiments, message aggregation is used to enhance communication efficiency in handling small messages. In these embodiments, messages having respective sizes that are greater than a predefined threshold are transmitted from the source processes to the destination processes directly, without aggregation. Messages smaller than the predefined threshold, however, are aggregated by the source processes before transmission of the aggregated messages to the destination processes. Various aggregation algorithms may be used for this purpose. In one embodiment, a multi-step aggregation algorithm is used, in which data blocks are scattered and gathered among different processes at each step. Most data blocks that are aggregated are transmitted multiple times, through some are sent only once,

Although the present embodiments are described specifically with reference to the all-to-all-v operations, the principles of these embodiments may similarly be applied in accelerating other collective operations in which message sizes are not known in advance, as noted above. Furthermore, although these embodiments are framed in terms of MPI operations and protocols, the principles of the present invention may alternatively be implemented, mutatis mutandis, in conjunction with other protocols. All such alternative implementations are considered to be within the scope of the present invention.

### System Description

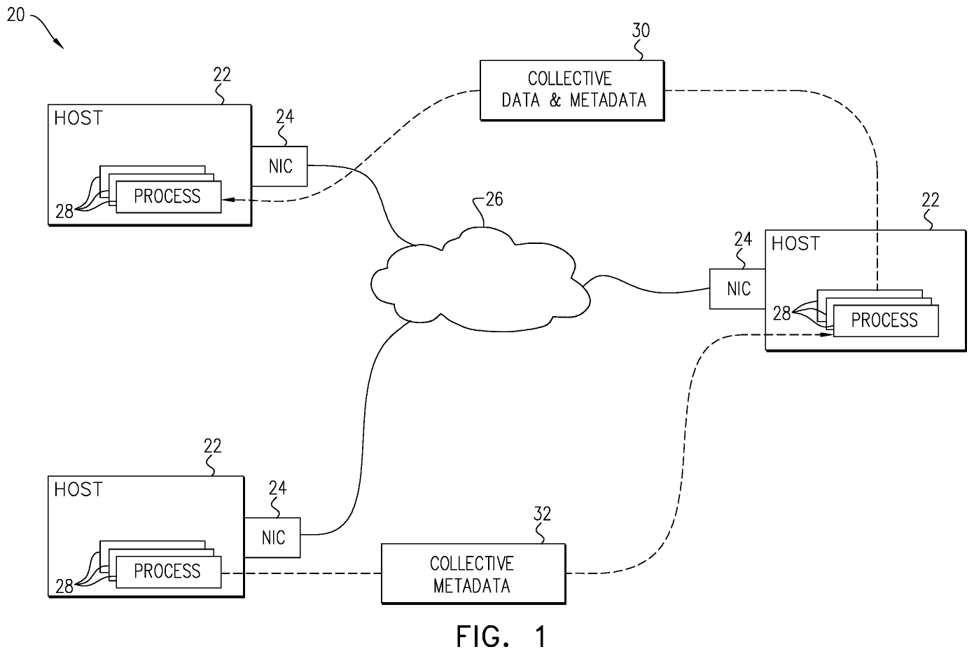

FIG. 1 is a block diagram that schematically illustrates collective communications in a computer system 20, in accordance with an embodiment of the invention. System 20 in this example comprises multiple processors, in the form of host computers 22, each comprising a central processing unit (CPU), memory, and other components as are known in the art. Each host computer 22 is connected by a respective network interface controller (NIC) 24 to a network 26, such as a high-speed switch fabric or other packet communication network. Although for the sake of simplicity only three host computers are shown in FIG. 1, in practice system 20 may comprise hundreds or thousands of host computers, interconnected by network 26. Host computers 22 in system 20 run a distributed HPC software application, in which multiple processes 28 run in parallel on different host computers. Typically (although not necessarily), each host computer 22 comprises multiple CPU cores, and each process 28 is assigned to run on a respective core.

Following certain computational stages in the distributed application, the program instructions invoke a collective operation, such as an all-to-all-v operation. In the context of this collective operation, system 20 defines an MPI communicator including all the participating processes 28, and each process has a respective rank within the communicator. In response to these instructions, each process 28 prepares data for transmission to all the other processes (ranks) within system 20, as well as metadata indicating how the data to be transmitted by the source processes in the collective operation are to be handled by destination processes that are to receive the data.

When the size of the data for transmission to a given destination is less than a certain threshold data size, the source process incorporates the data in a message 30 containing both the data and the metadata for transmission to the destination process. Messages 30 that are smaller than a predefined message aggregation threshold are aggregated and transmitted together to the respective destinations, typically via one or more intermediate destinations. This message aggregation can be carried out, for example, using techniques described in U.S. patent application Ser. No. 18/074,563, filed Dec. 5, 2022, whose disclosure is incorporated herein by reference. Alternatively or additionally, the message aggregation may take advantage of capabilities of NICs 24 in supporting collective operations, for example as described in the above-mentioned U.S. Pat. No. 10,521,283.

On the other hand, when the size of the data for transmission to a given destination process is greater than the threshold data size, the source process transmits a message 32 containing only the metadata to the respective destination process. The destination process uses the metadata in preparing a buffer in local memory to receive the data and in sending a request to the source process to transmit the data. Alternatively, message 32 may also contain a part of the data, in addition to the metadata.

Host computers 22 carry out the collective operations that are described herein, including particularly the present methods of selective data transmission and aggregation, under the control of software instructions. The software for these purposes may be downloaded to the host computers in electronic form, for example over network 26. Additionally or alternatively, the software may be stored on tangible, non-transitory computer-readable media, such as optical, magnetic, or electronic memory media.

### Methods for Transmitting Data and Metadata

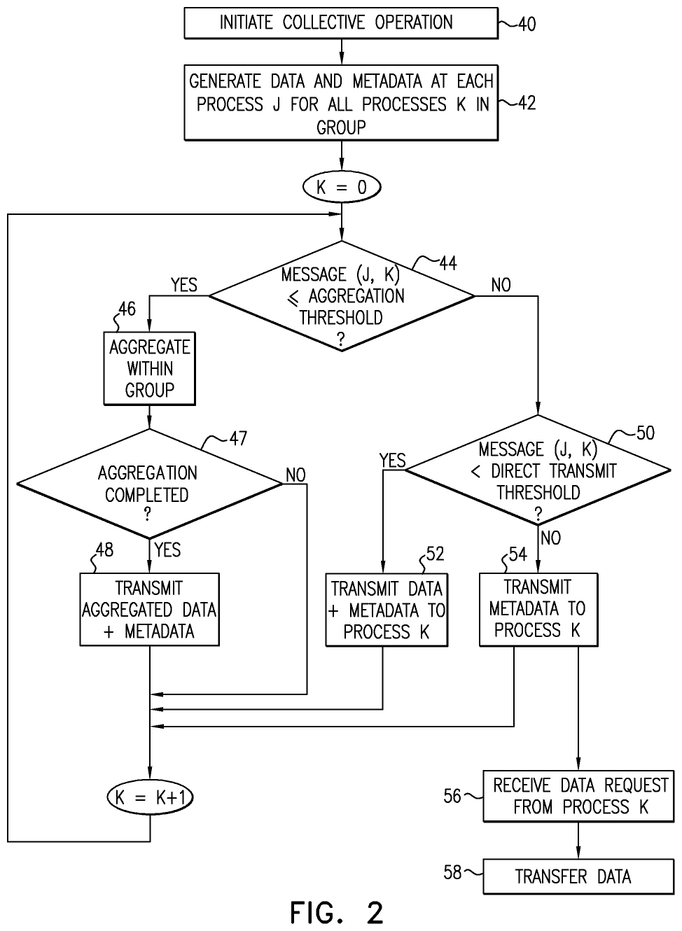

FIG. 2 is a flow chart that schematically illustrates a method for collective communications, in accordance with an embodiment of the invention. This method is carried out by a group of processes, such as processes 28 in system 20 (FIG. 1), when a collective operation is invoked over the group, at a collective initiation step 40.

In response to invocation of the collective operation, each of at least some of the processes in the group generates data for transmission to some or all of the other processes, at a data generation step 42. Typically, in any given collective operation, each process 28 can be both a source process for transmission of data and a destination process for receiving data. (When messages are aggregated, the destination processes also serve as intermediate destinations, which receive data in transit for aggregation and forwarding.) At step 42, the source processes also generate metadata that indicate how the data to be transmitted by the source processes in the collective operation are to be handled by the respective destination processes upon receiving the data. The metadata typically indicate the data size and may also provide information about the data type and/or the location of the data in a source buffer. In FIG. 2, the source processes are indicated by the index J, while the destination processes are indicated by the index K, so that the message to be sent from a given source process to a given destination process is identified as MESSAGE(J,K).

Each source process J evaluates the size of each of the messages (J,K) that the source process has prepared, at an aggregation evaluation step 44. The size in this case refers to the combined size of the respective metadata and data that are to be transmitted to each destination process K. If this size is less than a predefined aggregation threshold, for example less than 500 bytes, the source process will not transmit the message directly to the destination process but will rather aggregate the message with messages from other source processes that are directed to the same destination process, at an aggregation step 46. Any suitable message aggregation algorithm may be used for this purpose, such as the algorithms described in the above-mentioned U.S. patent application Ser. No. 18/074,563. Depending on the type and radix of the aggregation algorithm, the aggregating processes determine when aggregation of a given set of messages is complete, at an aggregation completion step 47. The aggregated messages, including data and metadata, are then transmitted to the destination processes, at an aggregated transmission step 48.

When the message (J,K) is larger than the aggregation threshold, the source process assesses whether the size of the data to be transmitted to destination process K is larger than a direct data transmission threshold, at a data evaluation step 50. If the data size is less than this threshold, the source process frames the data and metadata together in a single message and transmits the message to the destination process as part of the collective operation, at a combined transmission step 52.

When the size of the data destined for a given process K is found at step 50 to be larger than the direct data transmission threshold, the source process transmits only the metadata to process K as part of the collective operation, at a metadata transmission step 54. The source process then goes on to process the data for transmission to the next destination process K+1. After receiving the message sent at step 54, process K extracts the metadata from the message and uses the metadata in composing and transmitting a data request to the source process J, at a data request step 56. Upon receiving this request, the source process transmits the appropriate data to destination process K, at a data transmission step 58.

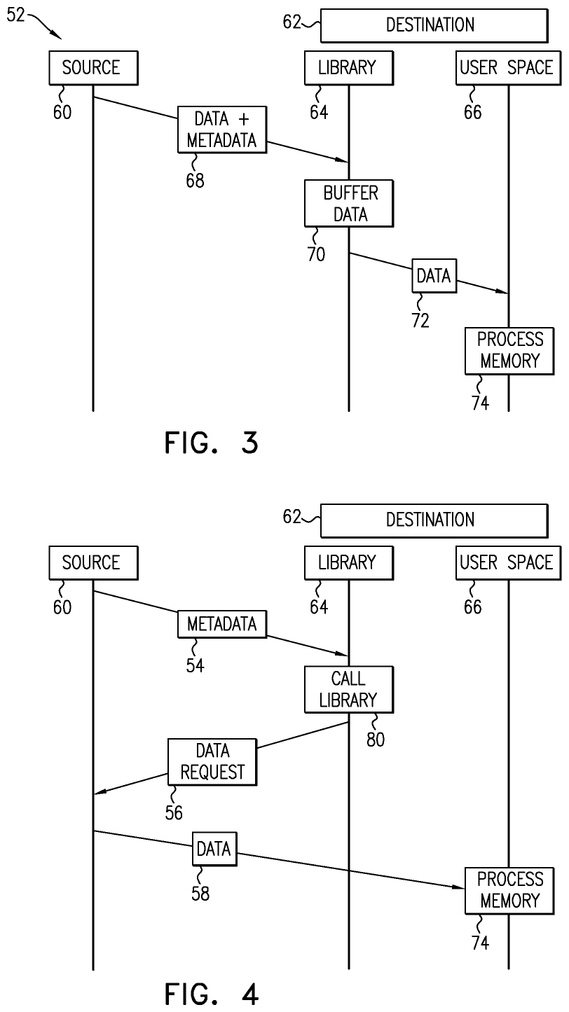

FIG. 3 is a ladder diagram that schematically shows details of an implementation of combined transmission step 52 (FIG. 2) in transferring data and metadata between a source 60 and a destination 62, in accordance with an embodiment of the invention. This diagram illustrates how messages containing both data and metadata are handled at destination 62. This implementation uses a library 64 of input/output and memory handling routines in receiving incoming messages and in transferring the data from the messages to a user space 66 where the destination process can access the data.

Source 60 transmits a combined message 68 containing data and metadata to destination 62. A routine in library 64 extracts the metadata from message 68, allocates a memory buffer 70 based on the metadata, and saves the incoming data in the buffer. Library 64 transfers data 72 from buffer 70 to a process memory 74 in user space 66, for input to the destination process, along with the data received from other source processes.

FIG. 4 is a ladder diagram that schematically shows details of an implementation of steps 54, 56, and 58 (FIG. 2), in conveying data from source 60 to destination 62, in accordance with another embodiment of the invention. This diagram illustrates how a data transfer is carried out when the size of the data is too large to be transmitted together with the metadata in the collective operation.

At step 54, source 60 transmits a message to destination 62 containing the metadata with respect to the data to be transferred. Destination 62 calls a library routine 80 to handle the data transfer based on the metadata. The library routine allocates a buffer in process memory 74 and transmits a data request to source 60 at step 56. For example, the data request may comprise an RDMA read request sent by NIC 24 (FIG. 1) of the destination computer and directed to an address in the memory of source 60 that was indicated by the metadata received by library 64 at step 54. NIC 24 of source 60 reads the data from the source memory and transmits an RDMA read response containing the data to destination 62 at step 58. Upon receiving the RDMA read response, the NIC of destination 62 will write the data directly to the designated buffer in process memory 74.

Alternatively, destination 62 may use other protocols to request transfer of the data from source 60. For example, destination 62 may send a message to source 60 at step 56 indicating the address of the designated buffer in process memory 74, and requesting data transfer to this buffer. NIC 24 of source 60 can then direct an RDMA write request containing the data to the designated buffer. Other implementations will be apparent to those skilled in the art after reading the above description and are considered to be within the scope of the present invention.

It will thus be appreciated that the embodiments described above are cited by way of example, and the present invention is not limited to what has been particularly shown and described hereinabove. Rather, the scope of the present invention includes both combinations and subcombinations of the various features described hereinabove, as well as variations and modifications thereof which would occur to persons skilled in the art upon reading the foregoing description and which are not disclosed in the prior art.

1. A method for collective communications, comprising:
invoking a collective operation over a group of computing processes in which the processes in the group concurrently transmit and receive data to and from other processes in the group via a communication medium;
composing, for transmission by source processes in the group, messages comprising metadata indicating how the data to be transmitted by the source processes in the collective operation are to be handled by destination processes that are to receive the data and also comprising in at least some of the messages the data to be transmitted by one or more of the source processes to one or more of the destination processes,
such that when a size of the data for transmission from a given source process to a given destination process is less than a predefined threshold, the data is incorporated together with the metadata in a message from the given source process to the given destination process, and when the size of the data for transmission from the given source process to the given destination process is greater than the predefined threshold, the message contains only the metadata without the data;
transmitting the composed messages concurrently from the source processes to the destination processes in the group over the communication medium; and
processing the data by the destination processes in response to the metadata comprised in the messages received by the destination processes, wherein when a given message contains the metadata without the data, the destination process retrieves the data from the source process using the metadata in the given message.

2. The method according to claim 1, wherein transmitting the composed messages comprises, for at least some of the messages:
transmitting the messages having respective sizes that are greater than a predefined threshold to the destination processes without aggregation; and
aggregating the messages for which the respective sizes are less than the predefined threshold and transmitting the aggregated messages to the destination processes.

3. The method according to claim 1, wherein processing the data comprises transmitting, responsively to the metadata in a message received by a destination process, a request from the destination process to the source process to convey the data from the source process to the destination process, whereby the source process transmits the data to the destination process responsively to the request.

4. The method according to claim 3, wherein transmitting the request comprises transmitting a remote direct memory access (RDMA) read request from the destination process to the source process.

5. The method according to claim 1, wherein invoking the collective operation comprises initiating an all-to-all-v, all-to-all-w, all-gather-v, gather-v, or scatter-v operation.

6. A system for collective communications, comprising multiple processors, which are interconnected by a communication medium and are programmed to run respective computing processes such that upon receiving an invocation of a collective operation over a group of the processes in which the processes in the group are to concurrently transmit and receive data to and from other processes in the group via a communication medium,
the processors compose, for transmission by source processes in the group, messages comprising metadata indicating how the data to be transmitted by the source processes in the collective operation are to be handled by destination processes that are to receive the data and also comprising in at least some of the messages the data to be transmitted by one or more of the source processes to one or more of the destination processes,
such that when a size of the data for transmission from a given source process to a given destination process is less than a predefined threshold, the data is incorporated together with the metadata in a message from the given source process to the given destination process, and when the size of the data for transmission from the given source process to the given destination process is greater than the predefined threshold, the message contains only the metadata without the data, and
the processors transmit the composed messages concurrently from the source processes to the destination processes in the group over the communication medium, and process the data in the destination processes in response to the metadata comprised in the messages received by the destination processes, wherein when a given message contains the metadata without the data, the destination process retrieves the data from the source process using the metadata in the given message.

7. The system according to claim 6, wherein for at least some of the messages, the processors are to transmit the messages having respective sizes that are greater than a predefined threshold to the destination processes without aggregation, and the processors are to aggregate the messages for which the respective sizes are less than the predefined threshold and transmit the aggregated messages to the destination processes.

8. The system according to claim 6, wherein the processors are to transmit, responsively to the metadata in a message received by a destination process, a request from the destination process to the source process to convey the data from the source process to the destination process, whereby the source process transmits the data to the destination process responsively to the request.

9. The system according to claim 8, wherein the request comprises a remote direct memory access (RDMA) read request transmitted from the destination process to the source process.

10. The system according to claim 6, wherein the collective operation comprises an all-to-all-v, all-to-all-w, all-gather-v, gather-v, or scatter-v operation.

11. A computer software product for collective communications among a group of computing processes running on processors, which are interconnected by a communication medium, the product comprising a tangible, non-transitory computer-readable medium in which program instructions are stored, which instructions cause the processors, upon receiving an invocation of a collective operation over a group of the processes in which the processes in the group are to concurrently transmit and receive data to and from other processes in the group via a communication medium:
to compose, for transmission by source processes in the group, messages comprising metadata indicating how the data to be transmitted by the source processes in the collective operation are to be handled by destination processes that are to receive the data and also comprising in at least some of the messages the data to be transmitted by one or more of the source processes to one or more of the destination processes,
such that when a size of the data for transmission from a given source process to a given destination process is less than a predefined threshold, the data is incorporated together with the metadata in a message from the given source process to the given destination process, and when the size of the data for transmission from the given source process to the given destination process is greater than the predefined threshold, the message contains only the metadata without the data, and
to transmit the composed messages concurrently from the source processes to the destination processes in the group over the communication medium, and to process the data in the destination processes in response to the metadata comprised in the messages received by the destination processes, wherein when a given message contains the metadata without the data, the destination process retrieves the data from the source process using the metadata in the given message.

12. The product according to claim 11, wherein for at least some of the messages, the instructions cause the processors to transmit the messages having respective sizes that are greater than a predefined threshold to the destination processes without aggregation, and to aggregate the messages for which the respective sizes are less than the predefined threshold and transmit the aggregated messages to the destination processes.

13. The product according to claim 11, wherein the instructions cause the processors to transmit, responsively to the metadata in a message received by a destination process, a request from the destination process to the source process to convey the data from the source process to the destination process, whereby the source process transmits the data to the destination process responsively to the request.

14. The product according to claim 13, wherein the request comprises a remote direct memory access (RDMA) read request transmitted from the destination process to the source process.

15. The product according to claim 11, wherein the collective operation comprises an all-to-all-v, all-to-all-w, all-gather-v, gather-v, or scatter-v operation.
